(19) United States
(12) Patent Application Publication
(10) Pub. No.: US 2002/0120616 A1
(43) Pub. Date: Aug. 29, 2002

(54) System and method for retrieving a XML (eXtensible Markup Language) document

(76) Inventors: Bo-Hyun Yun, Taejon (KR); Eui-Sok Chung, Taejon (KR); Keon-Hoe Cha, Taejon (KR); Hyun-Kyu Kang, Taejon (KR); Ji-Hyun Wang, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/836,316

(22) Filed: Apr. 18, 2001

(30) Foreign Application Priority Data
Dec. 30, 2000 (KR) 2000-86754

(51) Int. Cl. G06F 17/30

(52) U.S. Cl. 707/3

(57) ABSTRACT

A system and method retrieving a XML document includes a DTD (Document Type Definition) reduction module for making a configuration file for index to be used in indexing and retrieving a document in which a complicated DTD is compressed, an index module for index the configuration file and the XML document inputted from the DTD reduction module, an index information storage module for storing the index information inputted from the index module and a retrieval module for retrieving a general query and a structure query inputted by an user.

### FIELD OF THE INVENTION

The present invention relates to a system and method for retrieving a XML (eXtensible Markup Language) document; and, more particularly, a system and method for retrieving a XML document with an efficient indexing and a quick retrieval, by unifying contents and structures of documents and by indexing and retrieving them and a computer-readable record media storing instructions for performing such functions.

### DESCRIPTION OF THE PRIOR ART

A conventional full-text information retrieval system extracts an index term by analyzing contents of a document and provides a result obtained through a similarity calculation between a query term and an index term when a user's query is suggested. The above system has a problem in that a document is just considered as a continuity of words. So the systems have been applied for documents that are not structured. Namely, Classical document retrieval techniques have been designed and developed with an assumption that documents are individual and atomic units for retrieval process regardless of their length and their logical structure.

In the above retrieval, an user cannot retrieve a part of a document that the user wants to find and it takes a long time to retrieve a document because the retrieval is always performed for whole document. A conventional full-text retrieval system can be applied to only full-text retrieval for the whole document and also cannot utilize a structure of a document.

A conventional structured information retrieval system has just developed an information retrieval system for a SGML (Standard Generalized Markup Language) document and isn't developed for the XML document. Since the conventional system indexes and retrieves contents and structures of a complicated SGML document as it is, a considerable overhead of time and storage space in indexing and retrieving is produced. There is a demerit in which the conventional system makes it possible to index and retrieve a document only by considering a single field, not considering a plurality of fields.

### SUMMARY OF THE INVENTION

It is, therefore, an object of the present invention to provide a system and method retrieving a XML (eXtensible Markup Language) document and a computer-readable record media storing instruction for performing the system and method retrieving a XML document.

In accordance with an aspect of the present invention, there is provided a system retrieving a XML document, comprising a DTD (Document Type Definition) reduction module for making a configuration file for indexing, which a complicated DTD is compressed, to be used in indexing and retrieving a document, an indexing module for indexing the configuration file and the XML document inputted from the DTD reduction means, an index information storage module for storing the index information inputted from the indexing module and a retrieval module for retrieving a general query and a structure query inputted by an user.

In accordance with another aspect of the present invention, there is provided a retrieval method applied in the XML document retrieval system, comprising steps of converting a general query and a structure query inputted from an user into a query type corresponding to a retrieval engine, implementing similarity calculation between queries and document group by accessing the index information using the converted query, adjusting ranking of the document using the calculated similarity and presenting some elements or the full document that are ranked.

In accordance with further another aspect of the present invention, there is provided, in the XML document retrieval system equipped with a mass-storage processor, a computer-readable record media storing instructions for performing the functions of converting a general query and a structure query inputted from an user into a query type corresponding to a retrieval engine, implementing similarity calculation between queries and document group by accessing the index information using the converted query, adjusting a rank of the document using the calculated similarity and presenting some elements or the full document that are ranked.

### BRIEF DESCRIPTION OF THE DRAWINGS

The above and other objects and features of the present invention will become apparent from the following description of preferred embodiment given in conjunction with the accompanying drawings, in which:

FIG. 1 is a diagram showing an example of a general XML (eXtensible Markup Language) document;

FIG. 2 is a block diagram illustrating an information retrieval system based on a XML document according to the present invention;

FIG. 3 is a block diagram showing element indexing that indexes contents and structures according to the present invention;

FIG. 4 is a block diagram illustrating a retrieval system applied in a client/server structure according to the present invention; and

FIG. 5 is a diagram showing a BNF (Backs-Naur Form) to verify if a query is correct syntax using a Lex (Lexical analyzing generator) and a Yacc (Yet Another Compiler Compiler) and to convert the query into a step-query according to the present invention.

### DETAILED DESCRIPTION OF THE PREFERRED EMBODIMENTS

Hereinafter, a system and method for retrieving a XML (eXtensible Markup Language) document according to the present invention will be described in detail referring to the accompanying drawings.

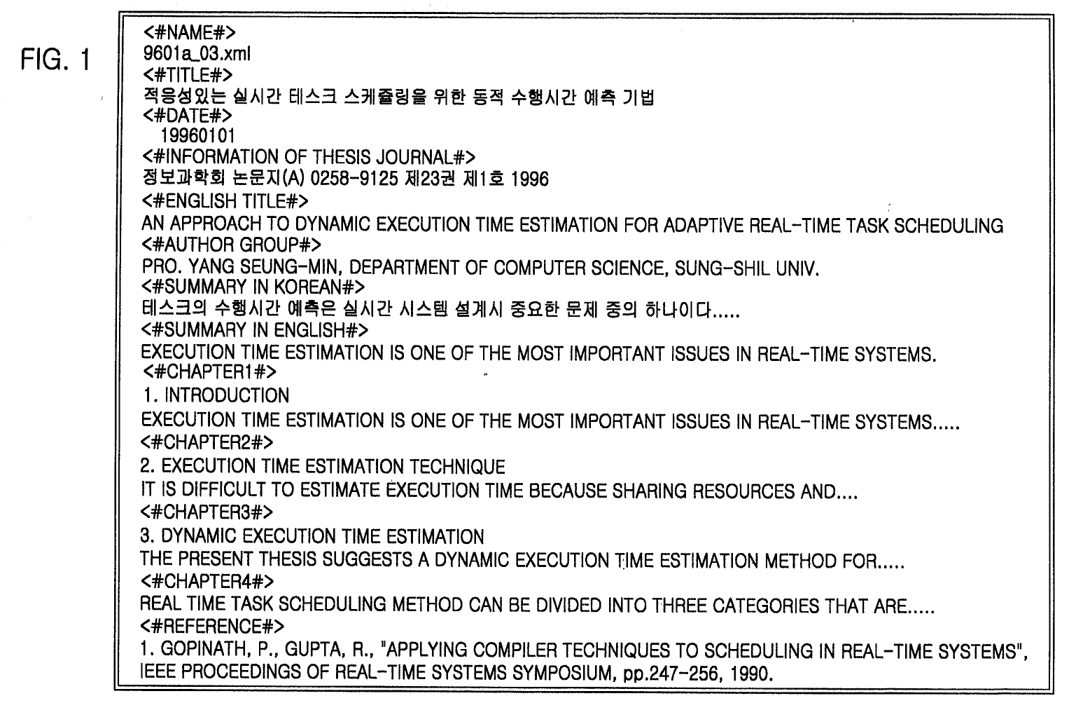

FIG. 1 is a diagram showing an example of a general XML document. As described in FIG. 1, XML document can take the same kinds of elements (e.g., chapter 1, chapter 2, chapter 3, etc.). To treat the above document, a conventional information retrieval system cannot be applied as it is. So an information retrieval system retrieving contents and structures is needed.

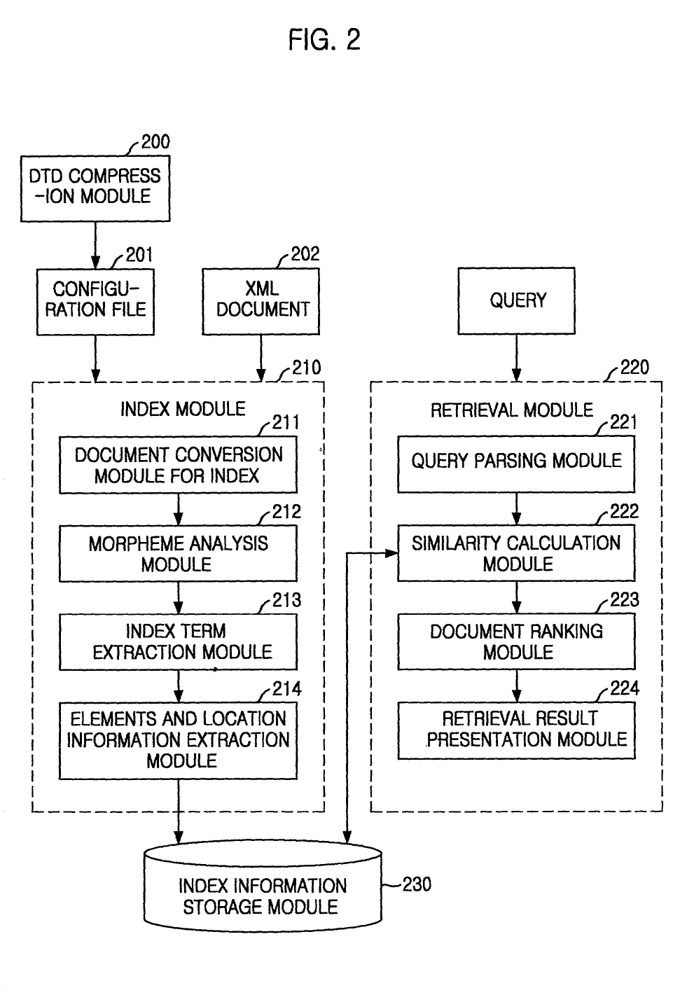

FIG. 2 is a block diagram illustrating an information retrieval system based on the XML document according to the present invention. The information retrieval system based on the XML document includes a DTD (Document Type Definition) reduction module 200 to make a configuration file for indexing through a simple DTD, which a complicated DTD is compressed, in order to be used in indexing and retrieving a document, an index module 210 for indexing a configuration file and the XML document inputted from the DTD reduction module 200, a retrieval module 220 retrieving a general query and a structure query inputted by an user and an index information storage module 230 for storing the index information inputted from the index module 210.

The index module 210 includes an index document conversion module 211 for making an index file by parsing the XML document after receiving input of the XML document 202 and the configuration file 201, a morpheme analysis module 212 for analyzing a morpheme of the index file made in the index document conversion module 211, an index term extraction module 213 for extracting the index term by implementing compound noun parsing, English stemming, Chinese to Korean conversion and figure recognition in the result of the morpheme analysis module 212 and elements and location information extraction module 214 for extracting the element and location information of the index term extracted in the index term extraction module 213.

The index information storage module 230 stores the index information, which is extracted in the element and location information extraction module 214, into an inverted index structure.

The retrieval module 220 includes a query parsing module 221 for converting a general query and a structure query inputted from an user into a query type corresponding to a retrieval engine, a similarity calculation module 222 for implementing similarity calculation between queries and document group by accessing the index information using the converted query in the query parsing module 221, a document ranking module 223 for adjusting ranking of the document using the calculated similarity from the similarity calculation module 222, a retrieval result presentation module 224 for presenting some elements or the full document or formatting some elements or the full document by using a XSL (eXtensible Style Language) that are ranked in the document ranking module 223.

The index term extraction module 213 extracts terms used as the indexes and its location information (e.g., sentence number, eujoul (means a word including suffix in Korean) number in the sentence) by analyzing morphemes of given string, stems string in case of English and converts a capital letter into a small letter according to setup. Chinese is converted into Korean by setup.

The index information storage module 230 stores posting information and document information as index information. Document frequency of the index term, location information, document number, index term frequency in the document, element number and index term frequency in the element are stored as the posting information. Document name, title, date, the number of elements, element number, length of element contents and element contents are stored as the document information.

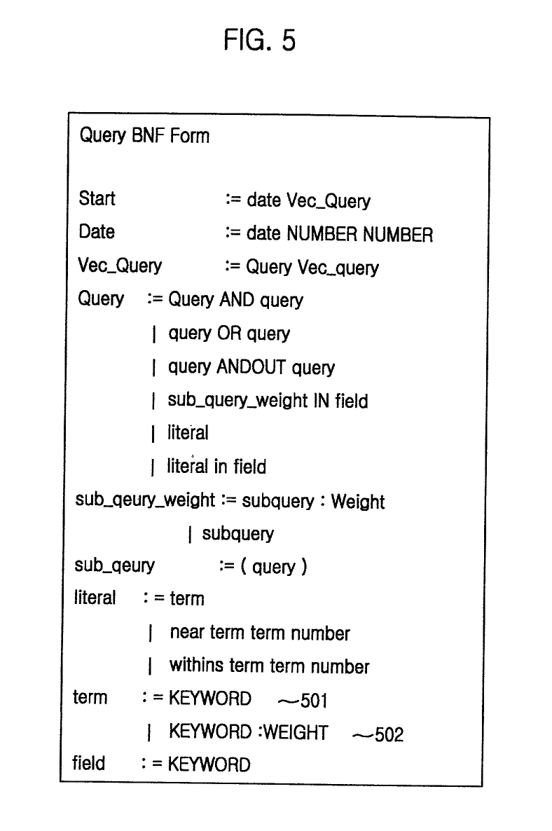

The query parsing module 221, after receiving a request of a user query, converts a query BNF (Backus-Naur form) based on following FIG. 5 into a step-query form by using Lex (Lexical analyzer generator) and Yacc (Yet Another Compiler Comiler) . Herein, the step-query is a query that can be used by the retrieval system by analyzing queries inputted by a user one by one. An example of the form is “AND information:0.7 in summary retrieval:0.5 in title”. It means that retrieves a document that has “summary” including “information” having 0.7 weight and that has “title” including “retrieval” having 0.5 weight. In a query of compound noun, the compound noun is separated into single nouns by using Boolean operators and the query is recomposed with a separated result. For example, a query “information retrieval” is recomposed with “(information AND retrieval OR information retrieval)” and is formed to the step-query. For English, a query is made and capital letters are converted into small letters by the stemming.

The similarity calculation module 222 implements the calculation as a following equation. A query Q that a query term qtₗ has weight qwₗ is following.

Q={(qtₗ, qwₗ), . . . , (qtᵢ, qwₗ), . . . , (qtₘ, qwₘ)}

D, which is document group of n numbers of results retrieved for one query term qtₗ, is following.

D={(dₗ, dwₗ), . . . (dⱼ, dwⱼ), . . . , (dₙ, dwₙ)}

Herein, a document dwⱼ has weight dwⱼ for a query term qtₗ.

A weight dwⱼ of the document dⱼ for the query term qtₗ is calculated, as followed.

$$d {w}_{j} = q {w}_{i} \times ( \frac{t {f}_{j}}{max t f} \times \frac{1}{d {f}_{j}} )$$

tfⱼ: index term frequency of query term qtₗ in the document

dfⱼ: document frequency of query term qtₗ in the document

max tf: maximum term frequency in the document

Generally, the weight calculation for the index term is performed in the index procedure. However, the reason of calculating the weights when retrieving is to perform dynamic insertion/deletion. That is to say, if the weight calculation is implemented in indexing, overhead that the weights of every index terms have to be calculated again whenever dynamic insertion/deletion is performed is produced.

In the document ranking module 223, ranking of the query Q and the document group D is supported by converting three models that are a Boolean retrieval model, an extended Boolean retrieval model and a vector space model.

In the Boolean retrieval model, the ranking of the document is implemented by a following equation. N-dimension vector W^{B} that is the total number of the document group is as follows:

W^{B}(wⱼ)_{j=1,n}

Vector element Wⱼ means ranking of the document dⱼ.

In case of Q_{and}, wⱼ=min(qw₁dwⱼ, qw₂dwⱼ)

In case of Qₒᵣ, wⱼ=max(qw₁dwⱼ, qw₂dwⱼ)

In case of Qₙₒₜ, wⱼ is

if(qwₗdwⱼ)>0,0

else, max_{l(qw}_{ₗ}_{=qw)}(qwₗdwⱼ, qwₗdwⱼ)

The similarity calculation of the extended Boolean retrieval model is implemented by a following equation. A coefficient indicating the degree of strictness is used as value 2 that is the most efficient value. N-dimension vector W^{E} that is the total number of the document group is as follows:

W^{E}=(wⱼ)_{j=1,n}

In case of

$${Q}_{or} , {w}_{j} = \sqrt[p]{\frac{{qw}_{1}^{p} {dw}_{j}^{p} + {qw}_{2}^{p} {dw}_{j}^{p}}{{qw}_{1}^{p} + {qw}_{2}^{p}}}$$

In case of Q_{and} ,

$${w}_{j} = 1 - \sqrt[p]{\frac{{qw}_{1}^{p} ( 1 - {dw}_{j}^{p} ) + {qw}_{2}^{p} ( 1 - {dw}_{j}^{p} )}{{qw}_{1}^{p} + {qw}_{2}^{p}}}$$

In case of Qₙₒₜ, wⱼ=1−dwⱼ

In the vector space model, the ranking of the document is implemented by a following equation. N-dimension vector W^{v} that is the total number of the document group is as follows:

W^{v}=(wⱼ)_{j=1,n}

wⱼ=qw₁dwⱼ+qw₂dwⱼ

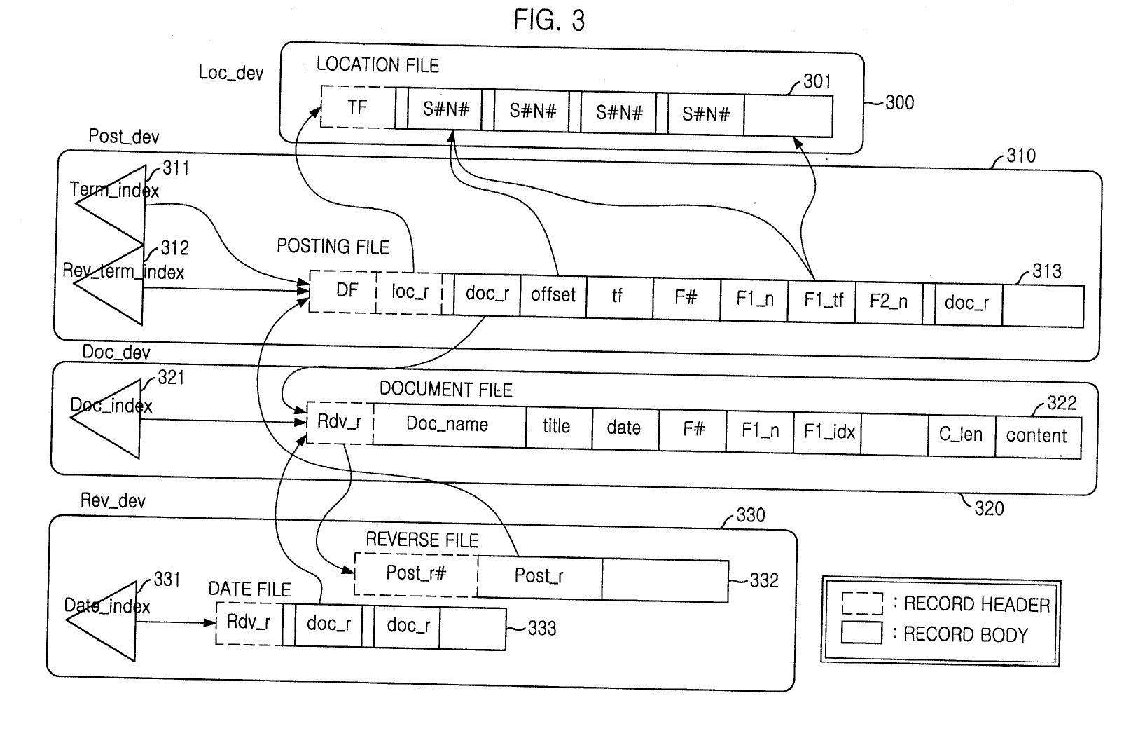

FIG. 3 is a block diagram illustrating the element indexing that indexes contents and structures according to the present invention. Referring to FIG. 3, the element indexing structure thinking much of retrieving and deleting speed has a posting record and a location information record per one index term to increase the retrieval speed.

An inverted index structure includes four divided devices, a Loc_dev 300, a Post_dev 310, a Doc_dev 320 and a Rev_dev 330. A Term_index 311 in the Post_dev 310 is a B+ tree index of an index term and the posting record and a Rev_term_index 312 is an index reversing the index term for a truncation treatment. A Doc_index 321 in the Doc_dev 320 is a B+ index posting name and contents record of a document and a Date_index 331 is an index for efficiently retrieving date.

A posting file 313 in the Post_dev 310 is a file storing posting information of each index term and a location file 301 is a file storing location information of each index term for quick retrieval speed. A reverse file 332 in the Rev_dev 320 is a file to store information posting the number of posting record and an actual posting record. A document file 322 is a file storing the contents of an actual document and a data file in the Rev_dev 330 has an inverted index list of a date document.

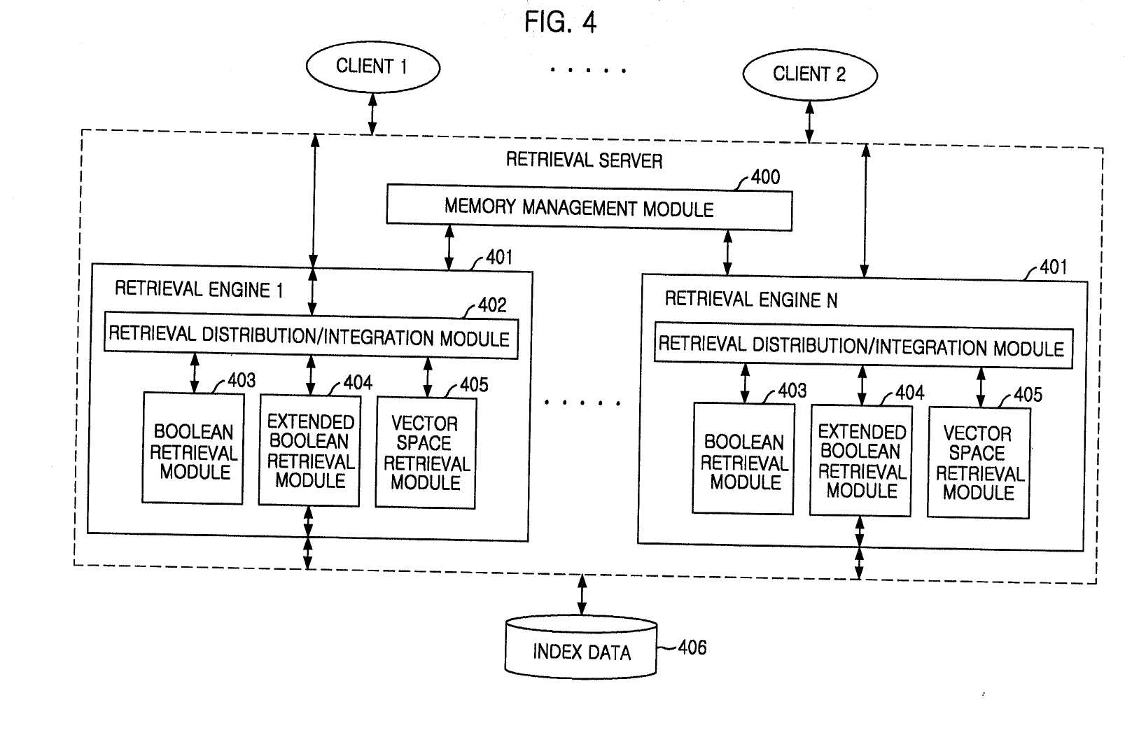

FIG. 4 is a block diagram illustrating a retrieval system applied in a client/server structure according to the prevent invention. To consider that a work temporarily using a lot of memory and then returning the memory to an operation system is repeated and a memory assignment demand for the operation system is a work requiring time, there is a memory management module 400 to prevent a lowering of retrieval efficiency when many users are connected. A retrieval engine includes a retrieval module using a Boolean retrieval module 403, an extended Boolean retrieval module 404 and a vector space retrieval module 405 through reference of index data 406 and a distribution/integration module 402 storing an interim result in retrieving.

FIG. 5 is a diagram showing a BNF (Backs-Naur Form) to verify if a query is correct syntax by using the Yacc and to convert the query into a step-query according to the present invention. A “KEYWORD” 501 means one word divided into a bank and a “WEIGHT” 502 is decimal number or real number. An nc (representing common noun), an nq (representing proper noun) or the like are used as a noun tag. “AND, and, &” implement Boolean and, “OR, or, |” mean Boolean or and “ANDNOT, −” implement Boolean ANDNOT. “:” is used to give weight of a query term and “( , )” is used to represent priority of Boolean operators. “in” is an element designation operator to implement element retrieval, “NEAR, near” is an operator retrieving two words dropped in number with a “near term term number” form and “WITHINS, withins” is an operator retrieving two words dropped into a sentence in the number with a “withins term term number” form. “Date from to” that can be operated in query start is an operator to implement date operation and implements vector retrieval in arraying query term.

The present invention can be applied to all document forms, such as HTML(Hyper Text Markup Language), XML, and SGML documents. If a part of HTML tags is structured, the retrieval in a web space and a USENET space can be easily applied for an internet retrieval engine. Also, if the SGML and the XML documents are divided into n number of logical parts (e.g. elements) using a parser, the elements retrieval can be implemented. The above retrieval engine can resolve the problems of a structured retrieval engine indexing all class information and element information. Namely, problems that an index space is considerably required and retrieval speed is lowered can be resolved.

The method of the present invention as afore-described is embodied by a computer program and this program can be stored in the computer-readable record media, such as a CDROM, a RAM, a ROM, a floppy disk and a magnetic-optical disk, etc.

It will be apparent to those skilled in the art that various modification and variations can be made in the present invention without deviating from the spirit or scope of the invention. Thus, it is intended that the present invention cover the modification and variations of this invention provided they come within the scope of the appended claims and their equivalents.

What is claimed is:

1. A system retrieving a XML document, comprising:
a DTD (Document Type Definition) reduction means for making a configuration file for index to be used in indexing and retrieving a document wherein a complicated DTD is compressed;
an index means for indexing the configuration file and the XML document inputted from the DTD reduction means;
an index information storage means for storing the index information inputted from the index means; and
a retrieval means for retrieving a general query and a structured query inputted by an user.

2. The system as recited in claim 1, wherein the index means includes:
an index document conversion means for making an index file by parsing the XML document after receiving an input of the XML document and the configuration file;
a morpheme analysis means for analyzing a morpheme of the index file made in the index document conversion means;
an index term extraction means for extracting the index term from results of the morpheme analysis means; and
elements and location information extraction means for extracting the elements and location information of the index term extracted in the index term extraction means.

3. The system as recited in claim 2, wherein the index term extraction means extracts the index term through implementation of compound noun parsing, English stemming, Chinese to Korean conversion and figure recognition.

4. The system as recited in claim 3, wherein the retrieval means includes:
a query parsing means for converting a general query and a structured query inputted from an user into a query type corresponding to a retrieval engine;
a similarity calculation means for implementing similarity calculation between queries and document group by accessing the index information using the converted query in the query parsing means;
a document ranking means for adjusting ranking of the document using the calculated similarity from the similarity calculation means; and
a retrieval result presentation means for presenting some elements or the full document that are ranked in the document ranking means.

5. The system as recited in claim 1, wherein, the index information storage means uses an index structure stored in an inverted index structure by coordinating contents and structures.

6. The system as recited in claim 4, wherein, the query parsing means parses a general query and a structured query by using a Lex (Lexical analyzing generator) and a Yacc (Yet Another compiler compiler).

7. The system as recited in claim 4, wherein the similarity calculation means calculates the similarity between queries and document group by calculating weight between queries and document.

8. The system as recited in claim 4, wherein, in the document ranking means, the document ranking is adjusted by modifying conventional Boolean model, advanced Boolean model and vector space model.

9. The system as recited in claim 4, wherein, in the retrieval result presentation means, the retrieval result is dynamically presented by formatting parts or all of document using XSL (extensible Style Language).

10. The system as recited in claim 4, an element in the retrieval result presentation means has one posting record and one location record to increase retrieval speed, as a structure attaching importance to the retrieval and deletion.

11. A retrieval method applied in the XML document retrieval system, comprising the steps of:
a) converting a general query and a structure query inputted from an user into a query type corresponding to a retrieval engine;
b) implementing similarity calculation between queries and document group by accessing the index information using the converted query;
c) adjusting ranking of the document using the calculated similarity; and
d) presenting some elements or the full document that are ranked.

12. The retrieval method as recited in claim 11, wherein the document ranking is adjusted by converting a Boolean model, an advanced Boolean model and a vector space model.

13. In the XML document retrieval system equipped with a mass-storage processor, a computer-readable record media storing instruction for performing the functions of:
converting a general query and a structure query inputted from a user into a query type corresponding to a retrieval engine;
implementing similarity calculation between queries and document group by accessing the index information using the converted query;
adjusting a rank of the document using the calculated similarity; and
presenting some elements or the full document that are ranked.
